(19) United States
(12) Patent Application Publication
(10) Pub. No.: US 2010/0110867 A1
(43) Pub. Date: May 6, 2010

(54) DISC PLAYBACK APPARATUS

(76) Inventor: Yoshitaka Nakamura, Tokyo (JP)

Correspondence Address: BIRCH STEWART KOLASCH & BIRCH, PO BOX 747, FALLS CHURCH, VA, 22040-0747, US

(21) Appl. No.: 12/532,378

(22) PCT Filed: Apr. 7, 2008
(86) PCT No.: PCT/JP2008/000889

§ 371 Date: Sep. 21, 2009

(30) Foreign Application Priority Data
Jun. 11, 2007 (JP) 2007 154215

(51) Int. Cl. G11B 7/00

(52) U.S. Cl. 369/124.01; G9B/7

(57) ABSTRACT

A disc playback apparatus characterized in, when receiving either a fast-forward playback request or a fast-backward playback request, calculating a target address by setting up a position which is close to a position at which information being read from a memory and being played back is stored in a disc as a movement destination of an optical pickup, and moving the optical pickup to the above-mentioned target address.

### FIELD OF THE INVENTION

The present invention relates to a disc playback apparatus having a function of preventing skipping.

### BACKGROUND OF THE INVENTION

A conventional disc playback apparatus temporarily stores information which is read from a disc by an optical pickup in an external memory, and then reads the information stored in the external memory to play back the information, in order to prevent skipping at the time of the disc playback which results from simplification of a vibration-proof system which is caused by the downsizing of the disc playback apparatus and incorporation of a plurality of discs into the disc playback apparatus. Therefore, a position (referred to as a pickup position from here on) at which the optical pickup reads the information stored in the disc differs from a position (referred to as a playback position from here on) at which the information which is being read from the external memory and is being played back by the disc playback apparatus is stored in the above-mentioned disc, and, when receiving a request for either a fast-forward playback or a fast-backward playback at the time of a playback of the disc, the disc playback apparatus has to start either a fast-forward playback process or a fast-backward playback process after first returning the position of the optical pickup to the playback position.

The operation of the disc playback apparatus will be explained hereafter.

FIG. 4 is a flow chart showing the operation of the conventional disc playback apparatus having the skipping preventing function at the time of performing a fast-forward (or fast-backward) playback process. When a user makes a request for either a fast-forward playback or a fast-backward playback, the conventional disc playback apparatus sets up the playback position as the movement destination of the optical pickup (step ST301). The disc playback apparatus then performs a mute setting on the audio being played back (step ST303), and erases (clears) the information stored in the external memory (step ST304). The disc playback apparatus then moves the optical pickup to (makes the optical pickup search for) the playback position which has been set as the movement destination (step ST305), and reads information stored in the disc and writes and stores the information in the external memory after completing the movement of the optical pickup (step ST306).

Next, the disc playback apparatus reads the information stored in the above-mentioned external memory (step ST307), and releases the audio mute setting and outputs an audio and also outputs time information (step ST308). When then receiving a request for a fast-forward playback, the disc playback apparatus sets up a position which is located forwardly, by a fixed time, from the playback position as the movement destination of the optical pickup, whereas when then receiving a request for a fast-backward playback, the disc playback apparatus sets up a position which is located backwardly, by a fixed time, from the playback position as the movement destination of the optical pickup (step ST309). In this case, steps ST302 and ST310 are the loop ends of either the fast-forward playback process or the fast-backward playback process, the disc playback apparatus repeats the processes of steps ST302 to ST310 unless either the fast-forward playback or the fast-backward playback is released.

FIG. 5 is a flow chart showing the operation of the conventional disc playback apparatus having the skipping preventing function at the time of releasing the fast-forward playback (or fast-backward playback). When receiving a request for release of either the fast-forward playback or the fast-backward playback while performing either the fast-forward playback or fast-backward playback process, the conventional disc playback apparatus makes an audio mute setting (step ST401), and erases (clears) the information stored in the external memory (step ST402). The disc playback apparatus then moves the optical pickup to the position which the disc playback apparatus has set as the movement destination (step ST403), and reads information stored in the disc and writes and stores the information in the external memory after completing the movement of the optical pickup (step ST404). Next, the disc playback apparatus reads the information stored in the above-mentioned external memory (step ST405), and releases the audio mute setting and outputs an audio while outputting time information (step ST406). The disc playback apparatus then returns a normal audio playback process.

Furthermore, when failing in reading information from the disc, the conventional disc playback apparatus makes an audio mute setting, and moves the optical pickup to a position at which the disc playback apparatus can read information from the disc (makes the optical pickup search for the position) so as to read information from the position at which the disc playback apparatus can play back the disc again. A problem is however that while making the above-mentioned search, the disc playback apparatus neither outputs any audio nor updates the display of the playback time, and therefore the user cannot grasp the playback status. To solve this problem, there has been provided a disc playback apparatus that, when failing in reading information from a disc, pseudoly updates a display of the playback time duration at time intervals different from those at which the disc playback apparatus displays the playback time duration at the time of a normal playback of the disc (for example, refer to patent reference 1).
[Patent reference 1] JP, 2006-331550,A

A problem with a conventional disc playback apparatus which is constructed as mentioned above is that because the movement destination of the optical pickup does not change from the playback position when either a fast-forward playback or a fast-backward playback has been started and either the fast-forward playback or the fast-backward playback is released during a time interval between step ST301 and step ST307 of FIG. 4, the position of the optical pickup does not change forever when a request for either a fast-forward playback or a fast-backward playback and release of either the fast-forward playback or the fast-backward playback are repeated continuously. Another problem is that because the audio is held muted and the time information is not outputted, any audio is not outputted at all from the speaker and the display time of the display does not vary. A further problem is that because the display time of the display does not vary until the process of step ST308 is completed when a fast-forward playback request has been made, the user has an impression that the responsibility of the disc playback apparatus is bad. Because in patent reference 1 only the case in which the disc playback apparatus fails in reading information from an information storage medium is described, the same problem arises in the disc playback apparatus when a request for a fast-forward playback process and a request for release of the fast-forward playback process are made alternately.

The present invention is made in order to solve the above-mentioned problems, and it is therefore an object of the present invention to provide a disc playback apparatus that prevents the position of an optical pickup from not changing when a request for either a fast-forward playback or a fast-backward playback and a request for release of either the fast-forward playback or the fast-backward playback are repeated continuously.

### DISCLOSURE OF THE INVENTION

A disc playback apparatus in accordance with the present invention is characterized in, when receiving either a fast-forward playback request or a fast-backward playback request, calculating a target address by setting up a position which is close to a position at which information being read from a memory and being played back is stored in a disc as a movement destination of an optical pickup, and moving the optical pickup to the above-mentioned target address.

In accordance with the present invention, when receiving either the fast-forward playback request or the fast-backward playback request, the disc playback apparatus calculates a target address by setting up a position which is close to the position at which information being read from the memory and being played back is stored in the disc as the movement destination of the optical pickup, and moves the optical pickup to the above-mentioned target address. Therefore, the present invention provides an advantage of being able to prevent the position of the optical pickup from not changing when a request for either a fast-forward playback or a fast-backward playback and a request for release of either the fast-forward playback or the fast-backward playback are repeated continuously.

### BRIEF DESCRIPTION OF THE FIGURES

FIG. 1 is a diagram showing a featured structure of a disc playback apparatus in accordance with this Embodiment 1;

FIG. 2 is a flow chart showing the operation of the disc playback apparatus in accordance with Embodiment 1 at the time of carrying out a fast-forward (or fast-backward) playback process;

FIG. 3 is a flow chart showing the operation of a disc playback apparatus in accordance with Embodiment 2 at the time of releasing a fast-forward (or fast-backward) playback process;

FIG. 4 is a flow chart showing the operation of a conventional disc playback apparatus having a skipping preventing function at the time of carrying out a fast-forward (fast-backward) playback process; and

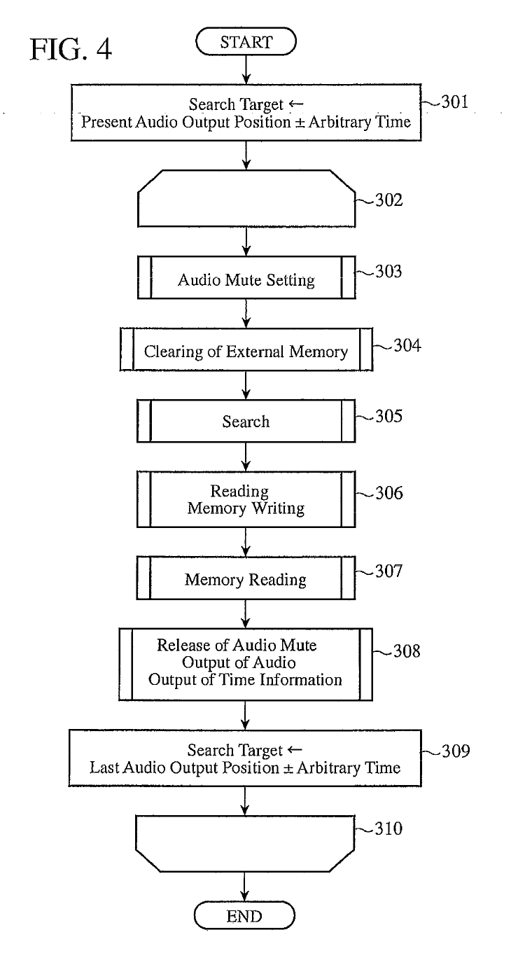

FIG. 5 is a flow chart showing the operation of the conventional disc playback apparatus having the skipping preventing function at the time of releasing a fast-forward (or fast-backward) playback.

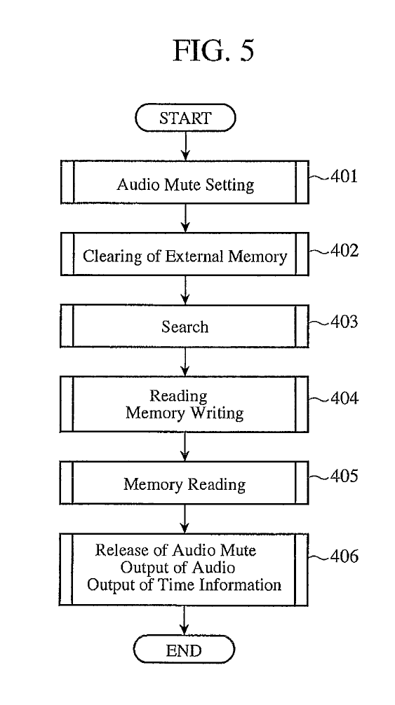

### PREFERRED EMBODIMENTS OF THE INVENTION

Hereafter, in order to explain this invention in greater detail, the preferred embodiments of the present invention will be described with reference to the accompanying drawings.

### Embodiment 1

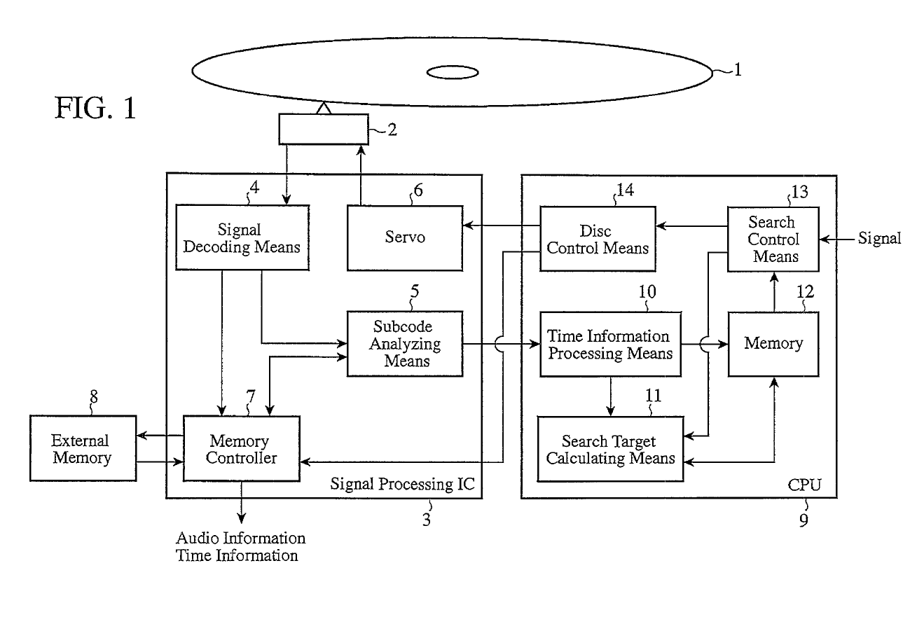

FIG. 1 is a diagram showing a featured structure of a disc playback apparatus in accordance with this Embodiment 1, and the disc playback apparatus in accordance with this Embodiment 1 is provided with an optical pickup 2, a signal processing IC (Integrated Circuit) 3, a CPU (Central Processing Unit) 9, and an external memory 8. In addition, the signal processing IC 3 is provided with a signal decoding means 4, a subcode analyzing means 5, a servo 6, and a memory controller 7 therein, and the CPU 9 is provided with a time information processing means 10, a search target calculating means 11, a memory 12, and a search control means 13 therein. In this Embodiment 1, an example of calculating a movement destination of the optical pickup by using a time will be explained.

The optical pickup 2 reads TOC (Table of Contents) information, audio information, etc. which are stored in a disc 1. The signal decoding means 4 decodes information read by the optical pickup 2. The subcode analyzing means 5 performs an analysis process of analyzing a subcode of information about a time among the information decoded by the signal decoding means 4 so as to acquire time information. Position information showing an absolute elapsed time from the start point of each track and a music number is included in this time information, and a search operation on the optical pickup 2, etc. are performed on the basis of this time information. The servo 6 controls a drive system (not shown) for driving the optical pickup 2 and the disc 1.

The memory controller 7 writes and stores both the audio information decoded by the signal decoding means 4 and the time information acquired by the subcode analyzing means 5 in the external memory 8 while bringing them into correspondence with each other. Furthermore, the memory controller 7 reads both the audio information and the time information which are stored in the external memory 8, and outputs the above-mentioned audio information to an audio output circuit (not shown) and also outputs the time information to a display means (not shown) by way of the subcode analyzing means 5 and the time information processing means 10, and further erases (clears) both the audio information and the time information which have been read thereby from the external memory 8. After D/A (Digital/Analog) converting the above-mentioned audio information into a signal, the audio output circuit amplifies the signal by using an amplifier and emits the signal to the air, as an audio, from a speaker. Furthermore, the display means displays a playback time duration on a display thereof on the basis of the above-mentioned time information.

The time information processing means 10 processes the time information acquired by the subcode analyzing means 5. The search target calculating means 11 calculates a target address indicating the movement destination of the optical pickup 2 on the basis of the time information processed by the time information processing means 10. In this case, when the disc playback apparatus is placed in fast-forward playback mode, a position which is close to the playback position and is located forwardly from the playback position by an arbitrary time is calculated as the position of the movement destination of the optical pickup 2. In contrast, when the disc playback apparatus is placed in fast-backward playback mode, a position which is close to the playback position and is located backwardly from the playback position by an arbitrary time is calculated as the position of the movement destination of the optical pickup 2. The memory 12 temporarily stores the time information processed by the time information processing means 10. When receiving either a fast-forward playback request signal or a fast-backward playback request signal from an operation unit (not shown), the search control means 13 instructs the search target calculating means 11 to calculate the target address, and also instructs a disc control means 14 to move the optical pickup 2 to the calculated target address (search). The disc control means 14 performs a search operation by controlling the servo 6 according to the instruction from the search control means 13.

Next, the operation of the disc playback apparatus will be explained.

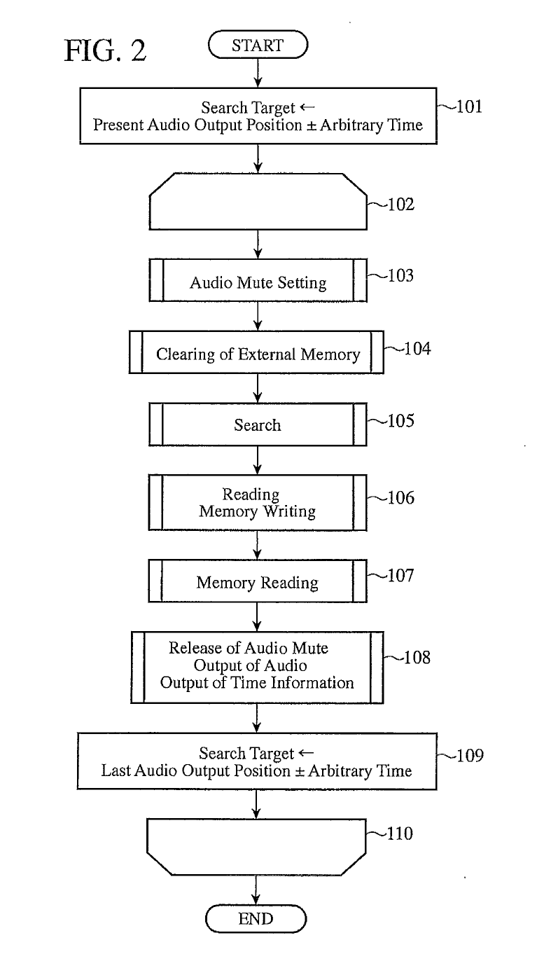

FIG. 2 is a flow chart showing the operation of the disc playback apparatus in accordance with Embodiment 1 at the time of carrying out a fast-forward (or fast-backward) playback process. When receiving either a fast-forward playback request signal or a fast-backward playback request signal, the search control means 13 instructs the search target calculating means 11 to calculate the movement destination of the optical pickup 2. When receiving an instruction indicating a fast-forward playback request from the search control means 13, the search target calculating means 11 calculates a position (referred to as a target position from here on) which is located forwardly, by an arbitrary time, from the playback position, as the movement destination of the optical pickup 2, on the basis of the time information processed by the time information processing means 10. In contrast, when receiving an instruction indicating a fast-backward playback request from the search control means 13, the search target calculating means 11 calculates a position (referred to as a target position from here on) which is located backwardly, by an arbitrary time, from the playback position, as the movement destination of the optical pickup 2, on the basis of the time information processed by the time information processing means 10.

The search control means 13 then sets the target position calculated by the search target calculating means 11 as the movement destination of the optical pickup 2 (step ST101), and then instructs the disc control means 14 to move the optical pickup 2 to the above-mentioned target position. When receiving the instruction from the search control means 13, the disc control means 14 instructs the memory controller 7 to stop the output of the audio information read from the external memory 8 to the audio output circuit and to erase the information stored in the external memory 8. According to the instruction from the disc control means 14, the memory controller 7 stops the output of the audio information to the audio output circuit to perform an audio mute setting (step ST103) and also erases the information stored in the external memory 8 (step ST104). Furthermore, the disc control means 14 controls the servo 6 so as to move the optical pickup 2 to the above-mentioned target position (search) (step ST105). When completing the movement to the above-mentioned target position, the optical pickup 2 starts reading information from the disc 1.

The signal decoding means 4 decodes the information which the optical pickup 2 has read, and outputs the audio information, among the decoded information, to the memory controller 7. The memory controller 7 writes and stores both the audio information outputted by the signal decoding means 4 and the time information acquired by the subcode analyzing means 5 in the external memory 8 while bringing them into correspondence with each other (step ST106). Furthermore, the memory controller 7 reads the information stored in the external memory 8 (step ST107), and releases the audio mute setting, outputs the audio information, among the read information, to the audio output circuit and also outputs the time information which is brought into correspondence with the above-mentioned audio information to the display means (step ST108).

Next, when the disc playback apparatus is performing a fast-forward playback, the search target calculating means 11 calculates a position which is located forwardly, by an arbitrary time, from the position at which the audio played back in step ST108 is stored as a new movement destination of the optical pickup 2, whereas when the disc playback apparatus is performing a fast-forward playback, the search target calculating means 11 calculates a position which is located backwardly, by an arbitrary time, from the position at which the audio played back in step ST108 is stored as a new movement destination of the optical pickup 2. The search control means 13 then sets the position calculated by the search target calculating means 11 as the movement destination of the optical pickup 2 (step ST109), and instructs the disc control means 14 to move the optical pickup 2 to the above-mentioned new movement destination. According to the instruction from the search control means 13, the disc control means 14 instructs the memory controller 7 to stop the output of the audio information read from the external memory 8 to the audio output circuit and to erase the information stored in the external memory 8.

Steps ST102 and ST110 are the loop ends of either the fast-forward playback process or the fast-backward playback process, the disc playback apparatus in accordance with this Embodiment 1 repeats the processes of steps ST102 to ST110 unless the search control means 13 receives either a fast-forward playback release signal or a fast-backward playback release signal. Because the operation of the disc playback apparatus at the time of releasing either the fast-forward playback or the fast-backward playback is the same as that of a conventional disc playback apparatus, the explanation of the operation will be omitted hereafter.

As mentioned above, when receiving either the fast-forward playback request signal or the fast-backward playback request signal, the disc playback apparatus in accordance with this Embodiment 1 sets up a position different from the playback position as the movement destination of the optical pickup 2. More specifically, when receiving the fast-forward playback request signal, the disc playback apparatus sets up a position which is located forwardly, by an arbitrary time, from the playback position as the movement destination of the optical pickup 2 and then moves the optical pickup 2 to the set-up position as mentioned, whereas when receiving the fast-backward playback request signal, the disc playback apparatus sets up a position which is located backwardly, by an arbitrary time, from the playback position as the movement destination of the optical pickup 2 and then moves the optical pickup 2 to the set-up position as mentioned. Therefore, the present embodiment offers an advantage of causing the optical pickup 2 to change in its position even when a state in which a fast-forward playback or a fast-backward playback has been started and the fast-forward playback or the fast-backward playback is released during a time interval between step ST101 and step ST107 is repeated continuously. Furthermore, because the display time also varies with the change in the position of the optical pickup 2, the user does not have an impression that the responsibility of the disc playback apparatus is bad. In this Embodiment 1, the disc playback apparatus outputs the time information to the display means in step ST108 of FIG. 2. As an alternative, the disc playback apparatus can output the time information to the display means after making an audio mute setting of step ST303. Because the disc playback apparatus promptly updates the playback time duration displayed on the display by doing in this way, there is provided an advantage of improving the responsibility of the disc playback apparatus to the user.

### Embodiment 2

In Embodiment 1, the example in which when receiving the fast-forward playback request signal or the fast-backward playback request signal, the disc playback apparatus sets up a position which is close to the playback position as the movement destination of the optical pickup 2 will be explained. In contrast, in this Embodiment 2, an example in which when receiving a fast-forward playback release signal or a fast-backward playback release signal, a position which is located forwardly from a position (referred to as a release position from here on) at which information read from a memory and played back at the time of the reception of the above-mentioned request is stored in the disc as the movement destination of the above-mentioned optical pickup 2 will be explained. Because a disc playback apparatus in accordance with this Embodiment 2 has the same structure as the disc playback apparatus in accordance with Embodiment 1, the explanation of the structure will be omitted hereafter. Also in this Embodiment 2, an example in which the disc playback apparatus calculates the movement destination of the optical pickup by using a time will be explained.

Next, the operation of the disc playback apparatus will be explained.

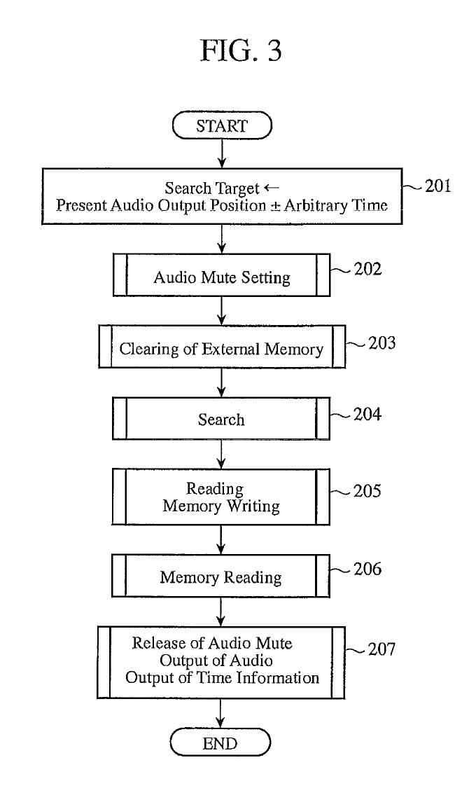

FIG. 3 is a flow chart showing the operation of the disc playback apparatus in accordance with Embodiment 2 when releasing a fast-forward (or fast-backward) playback. When receiving either a fast-forward playback release request signal or a fast-backward playback release request signal, a search control means 13 instructs a search target calculating means 11 to calculate the movement destination of the optical pickup 2. When receiving an instruction indicating the fast-forward playback release request from the search control means 13, the search target calculating means 11 then calculates a position (referred to as a release-time target position from here on) which is close to the release position and is located forwardly, by an arbitrary time, from the release position, as the movement destination of the optical pickup 2. In contrast, when receiving an instruction indicating the fast-backward playback release request from the search control means 13, the search target calculating means 11 then calculates a position (referred to as a release-time target position from here on) which is close to the release position and is located backwardly, by an arbitrary time, from the release position, as the movement destination of the optical pickup 2.

The search control means 13 then sets up the release-time target position calculated by the search target calculating means 11 as the movement destination of the optical pickup 2 (step ST201), and instructs a disc control means 14 to move the optical pickup 2 to the above-mentioned release-time target position. When receiving the instruction from the search control means 13, the disc control means 14 instructs the memory controller 7 to stop the output of the audio information read from an external memory 8 to an audio output circuit, and to erase the information stored in the external memory 8. According to the instruction from the disc control means 14, the memory controller 7 stops the output of the audio information to the audio output circuit to perform an audio mute setting (step ST202) and also erases the information stored in the external memory 8 (step ST203). Furthermore, the disc control means 14 controls a servo 6 so as to move the optical pickup 2 to the above-mentioned release-time target position (search) (step ST204). When completing the movement to the above-mentioned release-time target position, the optical pickup 2 starts reading information stored in the disc 1.

A signal decoding means 4 then decodes the information which the optical pickup 2 has read, and outputs the audio information, among the decoded information, to the memory controller 7. The memory controller 7 writes and stores both the audio information outputted by the signal decoding means 4 and the time information acquired by a subcode analyzing means in the external memory 8 while bringing them into correspondence with each other (step ST205). Furthermore, the memory controller 7 reads the information stored in the external memory 8 (step ST206), and releases the audio mute setting, outputs the audio information, among the read information, to the audio output circuit and also outputs the time information which is brought into correspondence with the above-mentioned audio information to a display means (step ST207), and then returns to the normal playback process.

As mentioned above, when receiving the fast-forward playback release signal, the disc playback apparatus in accordance with this Embodiment 2 sets up a position which is close to the release position and is located forwardly, by an arbitrary time, from the release position, as the movement destination of the optical pickup 2, whereas when receiving the fast-backward playback release signal, the disc playback apparatus calculates a position which is close to the release position and is located backwardly, by an arbitrary time, from the release position, as the movement destination of the optical pickup 2. Therefore, this Embodiment 2 offers the same advantage as that provided by Embodiment 1.

In above-mentioned Embodiments 1 and 2, the disc playback apparatus calculates the movement destination of the optical pickup on the basis of the time information. As an alternative, the disc playback apparatus can calculate the movement destination of the optical pickup on the basis of the position of the optical pickup.

### INDUSTRIAL APPLICABILITY

As mentioned above, the disc playback apparatus in accordance with the present invention moves the optical pickup to a position which is close to the position of the disc at where the information currently being played back is stored when receiving a request for either a fast-forward playback or a fast-backward playback. Therefore, the disc playback apparatus is suitable for use as a vehicle-mounted disc playback apparatus exhibiting good responsibility when such a request as mentioned and release are repeated continuously and equipped with a skipping preventing function, and so on.

1. A disc playback apparatus which temporarily stores information of a disc read by an optical pickup in a memory, and which reads the information stored in said memory to play back the information, characterized in that said disc playback apparatus comprises:
a signal decoder for decoding information read by said optical pickup;
a time information processor for processing time information from the information decoded by said signal decoder;
a search controller for receiving either a fast-forward playback request or a fast-backward playback request;
a search target calculator for, when said search controller receives either of said requests, performing a calculating operation by setting up a position which is close to a playback position of said disc as a movement destination of said optical pickup on a basis of the time information processed by said time information processor; and
a disc controller for controlling a servo for driving said optical pickup, and characterized in that
said search controller instructs said disc controller to move said optical pickup on a basis of a result of the calculating operation performed by said search target calculator.

2. The disc playback apparatus according to claim 1, characterized in that when said search controller receives the fast-forward playback request, said search target calculator calculates a position which is close to the playback position and is located forwardly, by an arbitrary time, from the playback position as the movement destination of said optical pickup.

3. The disc playback apparatus according to claim 1, characterized in that when said search controller receives the fast-backward playback request, said search target calculator calculates a position which is close to the playback position and is located backwardly, by an arbitrary time, from the playback position as the movement destination of said optical pickup.

4. (canceled)
